(19) United States
(12) Patent Application Publication
(10) Pub. No.: US 2007/0248809 A1
(43) Pub. Date: Oct. 25, 2007

(54) Interlayers Comprising Stable Infrared Absorbing Agents

(76) Inventors: Steven Vincent Haldeman, Hampden, MA (US); William Keith Fisher, Suffield, CT (US)

Correspondence Address: BRENC LAW;ANDREW BRENC, P.O. BOX 155, ALBION, PA, 16401-0155, US

(21) Appl. No.: 11/379,374

(22) Filed: Apr. 19, 2006

(51) Int. Cl. B32B 17/06; B32B 27/18; C08K 9/00

(52) U.S. Cl. 428/323; 428/426; 523/200; 524/403

(57) ABSTRACT

The present invention includes infrared absorbing agents that have been treated to resist hydrolytic effects caused by elevated moisture, interlayers comprising those agents, and various multiple layer glass panels that comprise those interlayers.

### FIELD OF THE INVENTION

The present invention is in the field of polymer sheets and multiple layer glass panels comprising infrared absorbing agents, and, more specifically, the present invention is in the field of polymer sheets and multiple layer glass panels comprising infrared absorbing agents that selectively absorb infrared radiation while resisting hydrolytic degradation.

### BACKGROUND

Poly(vinyl butyral) (PVB) is commonly used in the manufacture of polymer sheets that can be used as interlayers in light-transmitting laminates such as safety glass or polymeric laminates. Safety glass often refers to a transparent laminate comprising a poly(vinyl butyral) sheet disposed between two sheets of glass. Safety glass often is used to provide a transparent barrier in architectural and automotive openings. Its main function is to absorb energy, such as that caused by a blow from an object, without allowing penetration through the opening or the dispersion of shards of glass, thus minimizing damage or injury to the objects or persons within an enclosed area. Safety glass also can be used to provide other beneficial effects, such as to attenuate acoustic noise, reduce UV and/or IR light transmission, and/or enhance the appearance and aesthetic appeal of window openings.

In many applications it is desirable to use safety glass that not only has the proper physical performance characteristics for the chosen application, but also has light transmission characteristics that are particularly suitable to the end use of the product. For example, it will often be desirable to limit infrared radiation transmission through laminated safety glass in order to provide improved thermal properties.

The ability to reduce transmission of infrared radiation, and specifically near infrared radiation, can be a particularly desirable characteristic of multiple layer glass panels, and particularly for safety glass that is used in automotive and architectural applications. Reducing the transmission of infrared radiation can result in the reduction of heat generated by such radiation within an enclosed space.

Many examples exist in the art of compositions and methods to reduce infrared radiation transmission through multiple layer glass panels. Many of these, however, require modification of basic fabrication techniques, addition of layers to the final multiple layer product, or incorporation of agents that are expensive or block desirable visible light as well as infrared radiation.

Further, in applications in which moisture ingress into a polymer sheet occurs at a relatively high rate, for example in open edged or bilayer applications, the moisture can lead to hydrolysis of infrared absorbing agents, thereby reducing the infrared absorption ability of those agents.

Further improved compositions and methods are needed to enhance the characteristics of multiple layer glass panels comprising infrared absorbing agents, and specifically multiple layer glass panels comprising poly(vinyl butyral) layers, so as to impart stability without detrimentally affecting optical qualities.

### SUMMARY OF THE INVENTION

The present invention includes infrared absorbing agents that have been treated to resist hydrolytic effects caused by elevated moisture, interlayers comprising those agents, and various multiple layer glass panels that comprise those interlayers.

### BRIEF DESCRIPTION OF THE FIGURES

FIG. 1 represents a schematic illustration of a single infrared absorbing agent of the present invention having an infrared absorbing core within a moisture resistant coating.

### DETAILED DESCRIPTION

The present invention involves infrared absorbing agents and their use in interlayers and multiple layer glass panels comprising those interlayers, that can be used, for example, in automotive windshields and architectural applications. As disclosed herein, infrared absorbing agents comprising an infrared absorbing core disposed within a moisture resistant coating, as will be described in detail below, are incorporated into or onto polymer sheets that are useful as interlayers or layers within interlayers for use in multiple layer glass panel applications. As will be described in detail below, polymer sheets of the present invention can comprise any suitable polymer, and in preferred embodiments, polymer sheets comprise poly(vinyl butyral).

Previous attempts in the art to reduce infrared radiation include using various infrared reflective layers (see, for example, U.S. Pat. Nos. 6,391,400, 5,245,468, and 2002/0150744) or various infrared absorbing agents that are distributed on or within polymeric layers (see, for example, U.S. Pat. Nos. 6,737,159, 6,506,487, 6,620,872, 6,673,456, 2002/0054993, 2003/0094600, 2003/0122114, 2003/0054160, and 6,620,872 and International Patent Application WO02/077081). The use of separate infrared reflecting layers, however, can require time consuming and inefficient processing steps, while the use of infrared absorbing agents can present several difficulties, among which is the gradual hydrolysis and consequent degradation of the agent because of moisture ingress into the polymer layer. Water ingress problems can be particularly acute in applications such as bilayers and exposed edge laminates.

The present invention includes infrared absorbing agents that can be distributed within or on one or more polymer layers, and specifically polymer sheets, in an interlayer. The infrared absorbing agents of the present invention, which have an infrared absorbing core disposed within a moisture resistant coating, can be used in any conventional interlayer application, and are particularly useful in application in which excess moisture ingress occurs. The moisture resistant coatings of the present invention effectively protect the infrared absorbing cores from the deleterious effects of moisture, thereby stabilizing the infrared absorbing cores and providing longer effective infrared protection for the interlayer application.

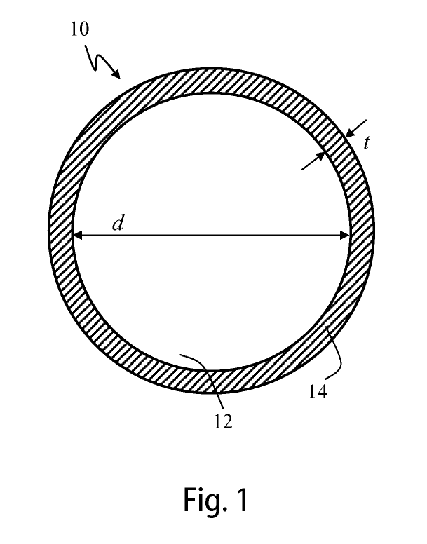

As shown generally at 10, in FIG. 1, which is a schematic representation of a cross section of one embodiment of an infrared absorbing agent of the present invention, an infrared absorbing core 12 is disposed within a moisture resistant coating 14. The infrared absorbing core 12 can be approximately spherical in shape, but it can also be non-spherical, for example, ovoid or irregularly spherical.

Infrared absorbing agents of the present invention can be disposed on or within one or more layers of an interlayer. In various embodiments, the infrared absorbing agents are disposed in or on a polymer sheet that is incorporated in an interlayer. In these embodiments, the interlayer can comprise only the single polymer sheet, or can be a multiple layer interlayer comprising the polymer sheet. Embodiments in which multiple layer interlayers are used include those that are known in the art, and include, for example and without limitation, interlayers having two or more polymer sheets laminated together to form a single interlayer, and interlayers having one or more polymer sheets laminated together with one or more polymer films, which will be described in detail below. In any of these embodiments, the infrared absorbing agents can be disposed on or within any one or more of the layers, including polymer sheets and polymer films, and the various layers can be the same or different. Further, infrared absorbing agents that are disposed on or within multiple layers can be the same or different, and can comprise a single agent or mixtures of two or more agents.

Exemplary multiple layer interlayer constructs include the following:
(polymer sheet)ₙ
(polymer sheet/polymer film/polymer sheet)ₚ

where n is 1 to 10 and, in various embodiments, is less than 5, and p is 1 to 5, and, in various embodiments, is less than 3.

Interlayers of the present invention can be incorporated into multiple layer glass panels, and, in various embodiments, are incorporated between two layers of glass. Applications for such constructs include automobile windshields and architectural glass, among others.

In embodiments in which an interlayer is disposed between two layers of glass, interlayers of the present invention incorporating infrared absorbing agents of the present invention are particularly useful where the edge of the multiple layer glass panel are exposed to the environment such as for automotive windshields and side windows.

In other embodiments of the present invention, interlayers comprising infrared absorbing agents are used in bilayers. As used herein, a bilayer is a multiple layer construct having a rigid substrate, such as glass or acrylic, with an interlayer disposed thereon. A typical bilayer construct is: (glass)//(polymer sheet)//(polymer film). The infrared absorbing agents of the present invention are particularly useful for bilayers because the exposed polymer film typically allows moisture ingress through the polymer film and into the polymer sheet. As with applications having two rigid substrates, bilayer embodiments can have one or more infrared absorbing agents disposed on or within one or more layers, which can be the same or different. Bilayer constructs include, for example and without limitation:
(Glass)//((polymer sheet)ₕ//(polymer film))_{g}
(Glass)//(polymer sheet)ₕ//(polymer film)

where h is 1 to 10, and, in various embodiments is less than 3, and g is 1 to 5, and, in various embodiments, is less than 3.

In further embodiment, interlayers as just described can be added to one side of multiple layer glass panel to act as a spall shield, for example and without limitation:
(Multiple Layer Glass Panel)//((polymer sheet)ₕ//(polymer film))_{g}
(Multiple Layer Glass Panel)//(polymer sheet)ₕ//(polymer film)

where h is 1 to 10, and, in various embodiments is less than 3, and g is 1 to 5, and, in various embodiments, is less than 3.

In addition to the infrared absorbing agents of the present invention having an infrared absorbing core disposed within a moisture resistant coating, one or more conventional infrared absorbing agents or infrared reflecting layers can be incorporated into interlayers of the present invention.

In various embodiments, solar control glass (solar glass) is used for one or more multiple layer glass panels of the present invention. Solar glass can be any conventional glass that incorporates one or more additives to improve the optical qualities of the glass, and specifically, solar glass will typically be formulated to reduce or eliminate the transmission of undesirable wavelengths of radiation, such as near infrared and ultraviolet. Solar glass can also be tinted, which results in, for some applications, a desirable reduction of transmission of visible light. Examples of solar glass that are useful in the present invention are bronze glass, gray glass, loE glass, and solar glass panels as are known in the art, including those disclosed in U.S. Pat. Nos. 6,737,159 and 6,620,872. As will be described below, rigid substrates other than glass can be used.

In various embodiments of the present invention, the infrared absorbing core/moisture resistant coating agents of the present invention are disbursed on or within a polymer sheet and/or a polymer film. The concentration of the infrared absorbing core/moisture resistant coating agents can be adjusted to suit the needs of the particular application. Generally, an amount of infrared absorbing core/moisture resistant coating agent will be added that is sufficient to impart the desired infrared absorbance on the sheet without also causing an unacceptable reduction in the transmission of visible light through the sheet. In various embodiments of the present invention, infrared absorbing core/moisture resistant coating agents are 10 to 500 parts per million (ppm by weight), 25 to 250 ppm, 20 to 200 ppm, 40 to 200 ppm, or 50 to 150 ppm of a polymer sheet.

Infrared absorbing agents of the present invention selectively absorb light in the infrared region of the electromagnetic spectrum. As used herein, an agent that “selectively absorbs” light in a particular region of wavelengths means that the agent significantly absorbs light in that particular region without also greatly absorbing light in other regions of the spectrum. In various embodiments, a polymer sheet of the present invention comprising an infrared absorbing core/moisture resistant coating agent absorbs at least 5%, at least 15%, at least 25%, at least 50%, at least 75%, or at least 90% of the infrared radiation between 700 nanometers and 2,000 nanometers while transmitting at least 60%, at least 70%, at least 80%, at least 90%, or at least 95% of the visible light.

### Infrared Absorbing Core

In various embodiments, the infrared absorbing core can be less than 1,000 nanometers (nm), less than 750 nanometers, less than 500 nanometers, less than 300 nanometers, less than 200 nanometers, less than 100 nanometers, less than 75, or less than 20 nanometers across its widest dimension, which, for the spherical embodiment shown in FIG. 1, is represented as “d”. In various embodiments the infrared absorbing core can be any of the above widths or less at its widest point for at least 80%, 90%, 95%, 99%, or 100% of all of the individual particles in the interlayer. That is, in some embodiments, most or almost all of the particles will fall within the given range, and some will be larger than the given range. It will be understood by those in the art that the size of the infrared absorbing core and the thickness of the moisture resistant coating, as well as the selection of materials, can be determined so as to suit the application and desired wavelength absorption.

The infrared absorbing core can comprise any composition that is conventionally used to absorb infrared radiation in interlayers, that can be formed into the appropriately sized and shaped particle, and that is compatible with the chosen moisture resistant coating. Examples of compositions that can be used include, but are not limited to, lanthanum hexaboride (LaB6), tin oxide, antimony tin oxide, alloys of tungsten oxide, doped zinc oxide, indium tin oxide, and mixtures of the foregoing. In one embodiment, the infrared absorbing core comprises lanthanum hexaboride. In various embodiments, the infrared absorbing core comprises a conventional infrared absorbing agent as disclosed in U.S. Pat. Nos. 6,506,487, 6,620,872, 6,673,456, 2002/0054993, 2003/0094600, 2003/0122114, 2003/0054160, and 6,620,872 and International Patent Application WO02/077081.

The infrared absorbing cores of the present invention can be manufactured by any conventional methods, as are known in the art. In various embodiments, nano sized infrared absorbing cores are formed through the use of a bead milling process.

### Moisture Resistant Coating

According to the present invention, the moisture resistant coating, shown as 14 in FIG. 1, can comprise any suitable moisture resistant composition that is compatible with the infrared absorbing core and the polymeric layer on or into which the infrared absorbing agent is dispersed, including, but not limited to, silicon dioxide, fluorosilanes, and silanes with n-alkane groups (see, for example, U.S. Patent Application 20050161642.

The infrared absorbing cores of the present invention can be coated with surface treatment agents containing silicon, such as silane type treatment agents, chlorosilanes, inorganic treatment agents having at least one alkoxyl group in the molecular structure, and organic treatment agents having at least one alkoxyl group at a molecular terminal on in a side chain. In general these agents are hydrophobic substances capable of preventing moisture permeation. These moisture resistant coatings can be in a proportion from 0.01 to 100 parts by weight based on 1 part by weight of the infrared absorbing cores in terms of the silicon contained in the surface treatment agent.

Silazane type treatment agents can also be used, and can be so strongly reactive with infrared absorbing cores, and in particular lanthanum hexaboride particles, that it can form covalent bonds with the lanthanum hexaboride particles on their particle surfaces to cover the lanthanum hexaboride particle surfaces. In addition, silazanes are lipophilic and have small molecular structure, and hence they can densely cover particle surfaces to make the outermost shells hydrophobic. The silazane type treatment agent can specifically include hexamethyldisilazane, cyclic silazanes, N,N-bis(trimethylsilyl)urea, N-trimethylsilyl acetamide, dimethyltrimethylsilylamine, diethyltrimethylsilylamine, trimethylsilylimidazole, and N-trimethylsilylphenylurea. Hydrolyzates of any of these or polymers thereof can also be used.

The chloro-groups of chlorosilane type treatment agent can also form covalent bonds with the lanthanum hexaboride particles on their particle surfaces. The chlorosilane type treatment agent can include methyltrichlorosilane, methyldichlorosilane, dimethyldichlorosilane, trimethylchlorosilane, phenyltrichlorosilane, diphenyldichlorosilane, trifluoropropyltrichlorosilane, heptadecafluorodecyltrichlorosilane, and vinyltrichlorosilane. Hydrolyzates of any of these or polymers thereof may also be used.

Inorganic treatment agent having at least one alkoxyl group in the molecular structure can also form covalent bonds through their alkoxyl groups with the infrared absorbing cores, and specifically lanthanum hexaboride particles, on their particle surfaces. This inorganic treatment agent can include silane type coupling agents, which may specifically include vinyltriethoxysilane, vinyltris(β-methoxyethoxy-)silane, β-(3,4-epoxycyclohexyl)ethyltrimethoxysilane, γ-glycidoxypropyltrimethoxysilane, γ-glycidoxypropyltriethoxy-silane, γ-glycidoxypropylmethyldiethoxysilane, γ-methacryloxypropylmethyldimethoxysilane, γ-methacryloxypropyltriethoxysilane, N-β-(aminethyl)-γ-aminopropylmethyldimethoxy-silane, N-β-(aminethyl)-γ-aminopropyltrimethoxysilane, γ-aminopropyltrimethoxysilane, γ-aminopropyltriethoxysilane, N-phenyl-γ-aminopropyltrimethoxysilane, γ-chloropropyltrimeth-oxysilane, and γ-mercaptopropyltrimethoxysilane. This inorganic treatment agent may further include the following compounds, which are classified as alkoxysilane surface treatment agents—tetramethoxysilane, methyltrimethoxysilane, dimethyldimethoxysilane, phenyltrimethoxysilane, diphenyldimethoxysilane, tetraethoxysilane, methyltriethoxysilane, dimethyldiethoxysilane, phenyltriethoxysilane, diphenyldiethoxysilane, hexyltrimethoxysilane, hexyltriethoxysilane, decyltriethoxysilane, decyltrimethoxysilane, trifluoropropyltrimethoxysilane, and heptadecatrifluorodecyltrimethoxysilane. Hydrolyzates of any of these or polymers thereof may also be used.

An organic treatment agent is also effective which has at least one alkoxyl group at a molecular terminal or in the side chain and whose backbone chain is a lipophilic high polymer such as epoxy, acryl, or urethane. Its alkoxyl groups form covalent bonds with the infrared absorbing core, and specifically lanthanum hexaboride particles, on their particle surfaces.

The moisture resistant coating 14 can have a thickness, shown as “t” in the spherical embodiment shown in FIG. 1, that is, in various embodiments, 2 to 100 nanometers, 3 to 50 nanometers, 4 to 10 nanometers; or less than 100 nanometers, less than 50 nanometers, less than 25 nanometers, less than 12 nanometers, less than 10 nanometers, less than 8 nanometers, less than 6 nanometers, less than 4 nanometers, or less than 2 nanometers. In various embodiments the moisture resistant coating can have any of the above-given thicknesses or less at the thickest point of the coating for at least 80%, 90%, 95%, 99%, or 100% of all of the individual infrared absorbing agent particles in the polymer sheet. That is, in some embodiments, most or almost all of the particles will fall within the given range, and some will be larger than the given range.

The moisture resistant coating can be formed on the infrared absorbing core in any conventional manner that is known in the art, including, but not limited to, a wet method where infrared absorbing cores, and particularly lanthanum hexaboride particles, are dispersed in an appropriate solvent, the surface treatment agent then added and mixed at an appropriate temperature to cause it to react with and coat the infrared absorbing core surfaces. Alternately the surface treatment agent can be sprayed onto infrared absorbing cores in a powder form, dried, and then heated to coat the particles.

The infrared absorbing core/moisture resistant coating agents of the present invention, in various embodiments, will absorb infrared radiation without significantly absorbing visible light.

### Polymer Film

As used herein, a “polymer film” means a relatively thin and rigid polymer layer that functions as a performance enhancing layer. Polymer films differ from polymer sheets, as used herein, in that polymer films do not themselves provide the necessary penetration resistance and glass retention properties to a multiple layer glazing structure, but rather provide performance improvements, such as infrared absorption character. Poly(ethylene terephthalate) is most commonly used as a polymer film.

In various embodiments, the polymer film layer has a thickness of 0.013 mm to 0.20 mm, preferably 0.025 mm to 0.1 mm, or 0.04 to 0.06 mm. The polymer film layer can optionally be surface treated or coated to improve one or more properties, such as adhesion or infrared radiation reflection. These functional performance layers include, for example, a multi-layer stack for reflecting infrared solar radiation and transmitting visible light when exposed to sunlight. This multi-layer stack is known in the art (see, for example, WO 88/01230 and U.S. Pat. No. 4,799,745) and can comprise, for example, one or more Angstroms-thick metal layers and one or more (for example two) sequentially deposited, optically cooperating dielectric layers. As is also known, (see, for example, U.S. Pat. Nos. 4,017,661 and 4,786,783), the metal layer(s) may optionally be electrically resistance heated for defrosting or defogging of any associated glass layers.

An additional type of polymer film that can be used with the present invention, which is described in U.S. Pat. No. 6,797,396, comprises a multitude of nonmetallic layers that function to reflect infrared radiation without creating interference that can be caused by metallic layers.

The polymer film layer, in some embodiments, is optically transparent (i.e. objects adjacent one side of the layer can be comfortably seen by the eye of a particular observer looking through the layer from the other side), and usually has a greater, in some embodiments significantly greater, tensile modulus regardless of composition than that of any adjacent polymer sheet. In various embodiments, the polymer film layer comprises a thermoplastic material. Among thermoplastic materials having suitable properties are nylons, polyurethanes, acrylics, polycarbonates, polyolefins such as polypropylene, cellulose acetates and triacetates, vinyl chloride polymers and copolymers and the like. In various embodiments, the polymer film layer comprises materials such as re-stretched thermoplastic films having the noted properties, which include polyesters, for example poly(ethylene terephthalate) and poly(ethylene terephthalate) glycol (PETG). In various embodiments, poly(ethylene terephthalate) is used, and, in various embodiments, the poly(ethylene terephthalate) has been biaxially stretched to improve strength, and has been heat stabilized to provide low shrinkage characteristics when subjected to elevated temperatures (e.g. less than 2% shrinkage in both directions after 30 minutes at 150° C.).

Various coating and surface treatment techniques for poly(ethylene terephthalate) film that can be used with the present invention are disclosed in published European Application No. 0157030. Polymer films of the present invention can also include a hardcoat and/or and antifog layer, as are known in the art.

### Polymer Sheet

The following section describes the various materials, such as poly(vinyl butyral), that can be used to form polymer sheets of the present invention.

As used herein, a “polymer sheet” means any thermoplastic polymer composition formed by any suitable method into a thin layer that is suitable alone, or in stacks of more than one layer, for use as an interlayer that provides adequate penetration resistance and glass retention properties to laminated glazing panels. Plasticized poly(vinyl butyral) is most commonly used to form polymer sheets.

As used herein, “resin” refers to the polymeric (for example poly(vinyl butyral)) component that is removed from the mixture that results from the acid catalysis and subsequent neutralization of the polymeric precursors. Resin will generally have other components in addition to the polymer, such as acetates, salts, and alcohols. As used herein, “melt” refers to a melted mixture of resin with a plasticizer and optionally other additives.

The polymer sheets of the present invention can comprise any suitable polymer, and, in a preferred embodiment, as exemplified above, the polymer sheet comprises poly(vinyl butyral). In any of the embodiments of the present invention given herein that comprise poly(vinyl butyral) as the polymeric component of the polymer sheet, another embodiment is included in which the polymer component consists of or consists essentially of poly(vinyl butyral). In these embodiments, any of the variations in additives, including plasticizers, disclosed herein can be used with the polymer sheet having a polymer consisting of or consisting essentially of poly(vinyl butyral).

In one embodiment, the polymer sheet comprises a polymer based on partially acetalized poly(vinyl alcohol)s. In another embodiment, the polymer sheet comprises a polymer selected from the group consisting of poly(vinyl butyral), polyurethane, polyvinyl chloride, poly(ethylene vinyl acetate), combinations thereof, and the like. In further embodiments the polymer sheet comprises poly(vinyl butyral) and one or more other polymers. Other polymers having a suitable glass transition temperature can also be used. In any of the sections herein in which preferred ranges, values, and/or methods are given specifically for poly(vinyl butyral) (for example, and without limitation, for plasticizers, component percentages, thicknesses, and characteristic-enhancing additives), those ranges also apply, where applicable, to the other polymers and polymer blends disclosed herein as useful as components in polymer sheets.

For embodiments comprising poly(vinyl butyral), the poly(vinyl butyral) can be produced by known acetalization processes that involve reacting poly(vinyl alcohol) (PVOH) with butyraldehyde in the presence of an acid catalyst, followed by neutralization of the catalyst, separation, stabilization, and drying of the resin.

In various embodiments, the polymer sheet resin comprising poly(vinyl butyral) comprises 10 to 35 weight percent (wt. %) hydroxyl groups calculated as poly(vinyl alcohol), 13 to 30 wt. % hydroxyl groups calculated as poly(vinyl alcohol), or 15 to 22 wt. % hydroxyl groups calculated as poly(vinyl alcohol). The polymer sheet resin can also comprise less than 15 wt. % residual ester groups, 13 wt. %, 11 wt. %, 9 wt. %, 7 wt. %, 5 wt. %, or less than 3 wt. % residual ester groups calculated as polyvinyl acetate, with the balance being an acetal, preferably butyraldehyde acetal, but optionally including other acetal groups in a minor amount, for example, a 2-ethyl hexanal group (see, for example, U.S. Pat. No. 5,137,954).

In various embodiments, the polymer sheet comprises poly(vinyl butyral) having a molecular weight at least 30,000, 40,000, 50,000, 55,000, 60,000, 65,000, 70,000, 120,000, 250,000, or at least 350,000 grams per mole (g/mole or Daltons). Small quantities of a dialdehyde or trialdehyde can also be added during the acetalization step to increase molecular weight to at least 350 g/mole (see, for example, U.S. Pat. Nos. 4,902,464; 4,874,814; 4,814,529; and, 4,654,179). As used herein, the term “molecular weight” means the weight average molecular weight.

Various adhesion control agents can be used in polymer sheets of the present invention, including sodium acetate, potassium acetate, and magnesium salts. Magnesium salts that can be used with these embodiments of the present invention include, but are not limited to, those disclosed in U.S. Pat. No. 5,728,472, such as magnesium salicylate, magnesium nicotinate, magnesium di-(2-aminobenzoate), magnesium di-(3-hydroxy-2-napthoate), and magnesium bis(2-ethyl butyrate)(chemical abstracts number 79992-76-0). In various embodiments of the present invention the magnesium salt is magnesium bis(2-ethyl butyrate).

Other additives may be incorporated into the polymer sheet to enhance its performance in a final product. Such additives include, but are not limited to, dyes, pigments, stabilizers (e.g., ultraviolet stabilizers), antioxidants, antiblock agents, IR absorbers, flame retardants, combinations of the foregoing additives, and the like, as are known in the art.

In various embodiments of polymer sheets of the present invention, the polymer sheets can comprise 20 to 60, 25 to 60, 20 to 80, 10 to 70, or 10 to 100 parts plasticizer per one hundred parts of resin (phr). Of course other quantities can be used as is appropriate for the particular application. In some embodiments, the plasticizer has a hydrocarbon segment of fewer than 20, fewer than 15, fewer than 12, or fewer than 10 carbon atoms.

The amount of plasticizer can be adjusted to affect the glass transition temperature (T_{g}) of the poly(vinyl butyral) sheet. In general, higher amounts of plasticizer are added to decrease the T_{g}. Poly(vinyl butyral) polymer sheets of the present invention can have a T_{g} of 40° C. or less, 35° C. or less, 30° C. or less, 25° C. or less, 20° C. or less, and 15° C. or less.

Any suitable plasticizers can be added to the polymer resins of the present invention in order to form the polymer sheets. Plasticizers used in the polymer sheets of the present invention can include esters of a polybasic acid or a polyhydric alcohol, among others. Suitable plasticizers include, for example, triethylene glycol di-(2-ethylbutyrate), triethylene glycol di-(2-ethylhexanoate), triethylene glycol diheptanoate, tetraethylene glycol diheptanoate, dihexyl adipate, dioctyl adipate, hexyl cyclohexyladipate, mixtures of heptyl and nonyl adipates, diisononyl adipate, heptylnonyl adipate, dibutyl sebacate, polymeric plasticizers such as the oil-modified sebacic alkyds, and mixtures of phosphates and adipates such as disclosed in U.S. Pat. No. 3,841,890 and adipates such as disclosed in U.S. Pat. No. 4,144,217, and mixtures and combinations of the foregoing. Other plasticizers that can be used are mixed adipates made from C₄ to C₉ alkyl alcohols and cyclo C₄ to C₁₀ alcohols, as disclosed in U.S. Pat. No. 5,013,779. and C₆ to C₈ adipate esters, such as hexyl adipate. In various embodiments, the plasticizer used is dihexyl adipate and/or triethylene glycol di-2 ethylhexanoate.

Any suitable method can be used to produce the polymer sheets of the present invention. Details of suitable processes for making poly(vinyl butyral) are known to those skilled in the art (see, for example, U.S. Pat. Nos. 2,282,057 and 2,282,026). In one embodiment, the solvent method described in Vinyl Acetal Polymers, in Encyclopedia of Polymer Science & Technology, 3^{rd} edition, Volume 8, pages 381-399, by B. E. Wade (2003) can be used. In another embodiment, the aqueous method described therein can be used. Poly(vinyl butyral) is commercially available in various forms from, for example, Solutia Inc., St. Louis, Mo. as Butvar™ resin.

The poly(vinyl butyral) polymer, plasticizer, and any additives can be thermally processed and configured into sheet form according to methods known to those of ordinary skill in the art. One exemplary method of forming a poly(vinyl butyral) sheet comprises extruding molten poly(vinyl butyral) comprising resin, plasticizer, and additives by forcing the melt through a die (for example, a die having an opening that is substantially greater in one dimension than in a perpendicular dimension). Another exemplary method of forming a poly(vinyl butyral) sheet comprises casting a melt from a die onto a roller, solidifying the resin, and subsequently removing the solidified resin as a sheet. In various embodiments, the polymer sheets can have thicknesses of, for example, 0.1 to 2.5 millimeters, 0.2 to 2.0 millimeters, 0.25 to 1.75 millimeters, and 0.3 to 1.5 millimeters.

For each embodiment described above comprising a glass layer, another embodiment exists, where suitable, wherein a glazing type material is used in place of the glass. Examples of such glazing layers include rigid plastics having a high glass transition temperature, for example above 60° C. or 70° C., for example polycarbonates and polyalkyl methacrylates, and specifically those having from 1 to 3 carbon atoms in the alkyl moiety.

The infrared absorbing core/moisture resistant coating agents of the present invention can be readily added to the polymer sheet by mixing the infrared absorbing core/moisture resistant coating agents into the plasticizer and then melt blending with resin before formation of the layer product. In other embodiments, infrared absorbing core/moisture resistant coating agents can also be dispersed in a volatile solvent, combined with resin powder, and then melted and extruded. The high temperatures that occur during processing will cause the volatile solvent to evaporate, leaving the infrared absorbing core/moisture resistant coating agents dispersed in the polymer sheet

Also included in the present invention are stacks or rolls of any of the polymer sheets and interlayers of the present invention disclosed herein in any combination.

The present invention also includes windshields, windows, and other finished glazing products comprising any of the interlayers of the present invention.

The present invention includes methods of manufacturing interlayers and glass panels comprising forming an interlayer or glass panel of the present invention using any of the polymer sheets of the present invention described herein.

Also included herein within the scope of the present invention are methods of reducing transmission of infrared and/or near infrared radiation through an opening, comprising the step of disposing in said opening any of the polymer sheet constructs of the present invention, for example, within a windshield or glass panel.

The present invention further includes a method of manufacturing a polymer sheet, comprising mixing any of the infrared absorbing core/moisture resistant coating agents of the present invention with a melt of any of the polymers described herein, and then forming a polymer sheet.

Various polymer sheet and/or laminated glass characteristics and measuring techniques will now be described for use with the present invention.

The clarity of a polymer sheet, and particularly a poly(vinyl butyral) sheet, can be determined by measuring the haze value, which is a quantification of light not transmitted through the sheet. The percent haze can be measured according to the following technique. An apparatus for measuring the amount of haze, a Hazemeter, Model D25, which is available from Hunter Associates (Reston, Va.), can be used in accordance with ASTM D1003-61 (Re-approved 1977)-Procedure A, using Illuminant C, at an observer angle of 2 degrees. In various embodiments of the present invention, percent haze is less than 5%, less than 3%, and less than 1%.

Pummel adhesion can be measured according to the following technique, and where “pummel” is referred to herein to quantify adhesion of a polymer sheet to glass, the following technique is used to determine pummel. Two-ply glass laminate samples are prepared with standard autoclave lamination conditions. The laminates are cooled to about −17° C. (0° F.) and manually pummeled with a hammer to break the glass. All broken glass that is not adhered to the poly(vinyl butyral) sheet is then removed, and the amount of glass left adhered to the poly(vinyl butyral) sheet is visually compared with a set of standards. The standards correspond to a scale in which varying degrees of glass remain adhered to the poly(vinyl butyral) sheet. In particular, at a pummel standard of zero, no glass is left adhered to the poly(vinyl butyral) sheet. At a pummel standard of 10, 100% of the glass remains adhered to the poly(vinyl butyral) sheet. For laminated glass panels of the present invention, various embodiments have a pummel of at least 3, at least 5, at least 8, at least 9, or 10. Other embodiments have a pummel between 8 and 10, inclusive.

The “yellowness index” of a polymer sheet can be measured according to the following: Transparent molded disks of polymer sheet 1 cm thick, having smooth polymeric surfaces which are essentially plane and parallel, are formed. The index is measured according to ASTM method D 1925, “Standard Test Method for Yellowness Index of Plastics” from spectrophotometric light transmittance in the visible spectrum. Values are corrected to 1 cm thickness using measured specimen thickness.

As used herein, “average particle size” is calculated by direct measurement of a large number of electron microscope images of dispersed particles.

### EXAMPLES

### Example 1

A dispersion of silica-coated lanthanum hexaboride nanoparticles in triethylene glycol bis(2-ethylhexanoate) plasticizer is obtained from Sumitomo Metal Mining Co. Ltd.

This dispersion is further diluted with triethylene glycol bis(2-ethylhexanoate) plasticizer and melt compounded into poly(vinyl butyral) resin such that there was 0.04 percent by weight of coated lanthanum hexaboride particles in the final extruded sheet. Sheet containing 0.04 percent by weight of uncoated lanthanum hexaboride nanoparticles is prepared in the same manner. Both sheets are 0.76 mm thick.

The two polymer sheets are laminated between two pieces of clear glass. The laminates are then exposed to a 50° C., 95% relative humidity environment for six weeks.

The laminate made from sheet containing uncoated lanthanum hexaboride showed obvious edge fade extending 25 millimeters into the laminate. Results of spectral measurements clearly showed a decrease in light absorption at 1000 nanometers wavelength indicating a loss of lanthanum hexaboride due to hydrolysis and the resulting destruction of lanthanum hexaboride crystals. Laminates made from sheet containing the coated lanthanum hexaboride showed just 2 millimeters of very slight edge fade.

By virtue of the present invention, it is now possible to provide interlayers, such as poly(vinyl butyral) sheet, and other polymer sheet, with superior, selective infrared transmission reduction characteristics that are resistant to degradation caused by moisture.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, and that the invention will include all embodiments falling within the scope of the appended claims.

It will further be understood that any of the ranges, values, or characteristics given for any single component of the present invention can be used interchangeably with any ranges, values, or characteristics given for any of the other components of the invention, where compatible, to form an embodiment having defined values for each of the components, as given herein throughout. For example, a polymer sheet can be formed comprising residual poly(vinyl alcohol) in any of the ranges given in addition to any of the ranges given for plasticizer, where appropriate, to form many permutations that are within the scope of the present invention but that would be cumbersome to list.

Any figure reference numbers given within the abstract or any claims are for illustrative purposes only and should not be construed to limit the claimed invention to any one particular embodiment shown in any figure.

Figures are not drawn to scale unless otherwise indicated.

Each reference, including journal articles, patents, applications, and books, referred to herein is hereby incorporated by reference in its entirety.

I claim:

1. An interlayer comprising an infrared absorbing agent, wherein said agent comprises an infrared absorbing core disposed within a moisture resistant coating.

2. The interlayer of claim 1, wherein said interlayer comprises poly(vinyl butyral).

3. The interlayer of claim 1, wherein said infrared absorbing core has an average diameter of less than 500 nanometers.

4. The interlayer of claim 1, wherein said infrared absorbing core has an average diameter of less than 200 nanometers.

5. The interlayer of claim 1, wherein said infrared absorbing core has an average diameter of less than 100 nanometers.

6. The interlayer of claim 1, wherein said infrared absorbing core comprises lanthanum hexaboride, indium tin oxide, antimony tin oxide, doped zinc oxide, or alloys of tungsten oxide.

7. The interlayer of claim 6, wherein said infrared absorbing core comprises lanthanum hexaboride, indium tin oxide, antimony tin oxide, or alloys of tungsten oxide.

8. The interlayer of claim 6, wherein said infrared absorbing core comprises lanthanum hexaboride.

9. The interlayer of claim 1, wherein said infrared absorbing core comprises lanthanum hexaboride and either indium tin oxide, antimony tin oxide, alloys of tungsten oxide, or a mixture of indium tin oxide, antimony tin oxide, and alloys of tungsten oxide.

10. The interlayer of claim 1, wherein said moisture resistant coating has a thickness of 2 to 100 nanometers.

11. The interlayer of claim 1, wherein said moisture resistant coating has a thickness of 4 to 10 nanometers.

12. The interlayer of claim 1, wherein said moisture resistant coating comprises a silane type treatment agent, a chlorosilane, an inorganic agent having at least one alkoxyl group in the molecular structure, or an organic treatment agent having at least one alkoxyl group at a molecular terminal on in a side chain.

13. The interlayer of claim 1, wherein said moisture resistant coating comprises silicon dioxide.

14. A multiple layer glass panel comprising an interlayer, wherein said interlayer comprises an infrared absorbing agent, wherein said agent comprises an infrared absorbing core disposed within a moisture resistant coating.

15. The panel of claim 14, wherein said panel is a bilayer.

16. The panel of claim 14, wherein said panel has exposed edges.

17. The panel of claim 14, wherein said panel is a windshield.

18. A method of manufacturing an interlayer, comprising:
providing a polymer melt;
incorporating an infrared absorbing agent into said polymer melt, wherein said infrared absorbing agent comprises an infrared absorbing core disposed within a moisture resistant coating; and,
extruding said melt to form said interlayer.

19. The method of claim 18, wherein said infrared absorbing agent is mechanically mixed with said polymer melt.
